(19) United States
(12) Patent Application Publication
(10) Pub. No.: US 2004/0057623 A1
(43) Pub. Date: Mar. 25, 2004

(54) Method for automated processing of digital image data

(76) Inventors: Thomas Schuhrke, Muenchen (DE); Martin Rother, Muenchen (DE)

Correspondence Address: Karl F. Milde, Jr. Esq., MILDE & HOFFBERG, L.L.P., Suite 460, 10 Bank Street, White Plains, NY, 10606, US

(21) Appl. No.: 10/638,209

(22) Filed: Aug. 8, 2003

(30) Foreign Application Priority Data
Sep. 24, 2002 (EP) 02021175.1

(51) Int. Cl. H04B 1/66; G06K 9/46; G06K 9/36

(52) U.S. Cl. 382/232; 375/240

(57) ABSTRACT

The invention concerns a method for the automated processing of digital image data in which the input image data are in compressed form, and in which several method steps must be applied to the compressed image data, or to the image data decompressed before processing, within the scope of image processing. Based on the invention, control data from the still-compressed image data are collected that automatically control the image processing steps.

### BACKGROUND OF THE INVENTION

The invention relates to a method for the automated processing of digital image data in which the input image data are in compressed form.

Methods to process digital image data have long been known. There are two conventional approaches for digital image data that are in compressed form.

A first approach is to decompress the compressed digital image data before the image data are processed. Processing of the image data then progresses as described in DE 36 29 409. Here, various filters and characteristic curves are used to process the data. Thus, for example, a high-pass signal isolated by a filter is amplified by means of a characteristic curve in order to increase image detail contrast, or in other words, focus is increased. It is further suggested to suppress the median noise signal occurring (within the high-pass signal) in order to reduce grain. This suppression also occurs according to a characteristic curve. Further, it is recommended during this step to apply varying characteristic curves to image data of varying brightness in order to influence contrast within the image data differently.

Processing of digital image data generally includes alterations to the contrast, color saturation, focus, density or density range, graininess, and color tones. A brief treatment of this image processing method is given in the text Fotografie des Fonds der chemischen Industrie (Fundamentals of the Chemical Industry), 1999 Edition, beginning on page 55. Further. Local image modifications such as the retouching of so-called red-eye that may occur during flash exposures are known. As soon as a printable image is created as a result of one of the illustrated image processing methods, it is generally re-compressed for transmission from the image processing to an output device or a storage medium. A disadvantage of this approach is that much computer time and capacity is required because of the very costly decompression and compression processes.

For this reason, image processing methods have been developed that may be directly used on compressed data. One of these methods is given, for example, in “Edge Enhancement of Remote Sensing Image Data in the DCT Domain,” Image and Vision Computing 17 (1999), pp. 913-921. This text describes how contrast increase and edge-sharpening may be undertaken to image data that are in JPEG format.

Independent of whether such image processing methods are applied to compressed or pre-decompressed data, it may occur as soon as the application of the image processing method is automated that the impression of the image may be degraded overall by the method, even if the image-processing method is optimized and even if it has a positive effect on most of the images. This may lead to complaints by the customer, and is thus to be avoided.

### SUMMARY OF THE INVENTION

It is thus a principal object of the present invention to improve the reliability and efficiency of conventional image-processing methods so that image deterioration may be avoided by means of automatic image processing.

This object, as well as other objects which will become apparent from the discussion that follows, are achieved, according to the invention, by a method wherein the image-processing steps are automatically controlled based upon control data extracted from the compressed image data.

According to the invention, digital image data to be processed that are in compressed form are analyzed before processing, so that information may be gained from this relatively small amount of data with low expenditure of computer time and capacity that may be used in the method according to the invention. From this data set that has been reduced by compression, characteristics of image data—either the entire image or the properties of local image content—may be deduced very quickly and simply and used as control data for image processing, so that the data may be adapted to the specific characteristics of the image to be processed, and may be optimized to these characteristics. Such control data could theoretically be obtained from the decompressed image data, but this is much more costly since, in order to determine the control data in this case, a much larger data set must be scanned, and often very time-intensive processing steps such as, for example, a Fourier transformation would be required in order to obtain control data for processing of the image. This would represent an enormous computing time, and thus is not practical for rapid photographic copying devices. On the other hand, since compressed data are more limited in scope, control data may be obtained much more quickly and easily from this data set than from the entire data set, so that this process may be used in automated, rapid photographic-copying devices or digital printers with pre-programmed image processing without delaying the entire image processing unnecessarily.

A great advantage of using compressed image data to determine control data for image processing is the fact that, transformations are performed in the course of the compression process in general that have proved unusually useful during determination of control data. For example, data compressed using JPEG or JPEG 2000 are frequency-transformed, so that the control data may just as easily be obtained as during decompression of the data which may be obtained only after very expensive Fourier transformations of the entire image data set.

A particularly advantageous embodiment of the invention provides that control data extracted from the compressed data be used in selecting image-processing steps within the overall image-processing method, thus individually shaping the image processing to be used for each image. Thus, for some images, special processing steps advantageous for them will be performed, while they may be omitted for other images with image content for which these image-processing steps are not suited. Thus, computer time may be saved because unsuitable image-processing steps are omitted, thus avoiding image deteriorations caused by the use of image-processing steps unsuitable for the image content. It may also be advantageous to select the sequence of image-processing steps depending on the determined control data, since a better result may often be attained if the image-processing steps are performed in a different order corresponding to the image content. Particularly, there are images, for example, with predominantly homogenous surfaces that may be negatively affected by the use of focus-sharpening algorithms, where it is better not to use focus sharpening. Further, the use of focus-sharpening algorithms is critical for images that are a computer-generated graphics. As soon as it is recognized from the compressed image data that the image is very homogenous or is a computer graphic, and that it is advantageous not to employ the “sharpening” image-processing step for this image, the control recognizes that the “sharpening” image-processing step should not be employed during processing of the analyzed image data.

A further example for the control of image processing based on the analysis of compressed image data consists of deciding the image resolution from the compressed data, and, based on this, establishing potential image enlargements. This means that, for image data of very low resolution, image-processing steps that cause enlargement of the image beyond a specified limit (that are necessary when, for example, a portion of the image is enlarged) are no longer allowed.

An additional, advantageous embodiment provides for selection or determination of the parameters used within the image-processing steps dependent on the control data extracted from the compressed data set. Thus, individual image-processing steps or image-processing methods such as, for example, focus sharpening, contrast alteration, grain reduction, color alterations, or other known image-processing methods applicable to the image content may be adapted individually to the image content.

Each image to be processed is thus searched in compressed form, and the control data resulting from the search are used to formulate an image-processing method ideal for the image. Use of an image-processing method ideal for each image prevents images or image areas to be negatively adulterated in that image-processing methods unsuitable for this image content or image-processing methods with unsuitable parameters are not used. Thus, each image may be individually produced by means of the ideal image-processing method optimally suited to the displayed image content.

In order to keep computer-time expense to a minimum during extraction of control data, it is particularly advantageous to acquire the control data from only one of the characteristically three available color channels characterizing the image. The compressed image data are generally present in three channels during processing of photographic data. Image data consist of a data set for brightness and two other color channels that reproduce the color content. The invention might be just as well used for data that are in another color space representation. Thus, RGB data, or data that contain a red, a green, and a blue color component may also be handled by the invention.

However, if one works with a luminance signal and two chrominance signals, one may not only obtain control data for image-processing steps or parameters that may derive from the brightness or brightness contrasts of the images, but also control signals based on the color of images or specific image contents that are identified by the presence of specific colors. It is more than adequate to observe the luminance signal in order to obtain data that permit efficient control of the image processing.

Advantageously, the compressed data are decompressed to the point that the frequency spectrum of the image data is revealed, i.e., decompression of data is halted before the reverse transformation results in the spatial dimensions. Thus, only the compression step of the encryption is reversed so that the transformed, quantified coefficients of the image data that reflect the frequency spectrum of the image may be used in order to obtain the control data for image processing. This frequency spectrum essentially contains all information necessary to characterize the image content and thereby perform a suitable selection of image-processing steps and parameters for these image-processing steps.

An advantageous embodiment of the invention provides for the use of transformed, quantified coefficients of the overall image of an image data set in order to extract the proper control data. Depending on the characteristics of the overall image, image-processing steps determined to be significant are automatically considered and are implemented, while others that would lead to a negative result are discarded. Even the degree of intensity, or the parameters to be employed by each individual image-processing step, may be deduced from the characteristics of the overall image.

In an advantageous embodiment of the invention, control data for image processing may be obtained from the transformed, quantified coefficients that correspond to the lowest frequencies in the frequency spectrum of the image data. This involves the so-called DC components for image data compressed using JPEG. Since the image data is divided into blocks of 8×8 bits during JPEG compression, all DC components of the image correspond to a data set reduced by a resolution factor of 8. In JPEG 2000, this would be correspondingly the low-frequency components from the Wavelet transformation. This is a data set that has been very efficiently reduced, but which essentially contains all density information of the image. This data set may be used in order to select suitable exposure conditions for the image reproduction. An image-processing method for this technique is described, for example, in DE 197 51 464. Here, available decompressed digital image data are analyzed over several images in order to establish characteristics of the camera used to capture the images. Such camera characteristics that are immersed in the image data may be taken into account and corrected upon identification during image reproduction. It is, however, very costly to analyze this entire data set as described in DE 197 51 464 across several images, since the amount of data is very large. It would also be possible to reduce the data set in order to perform analysis for the exposure conditions with the reduced data set. This, in turn, is also a time-consuming computing step that must be performed in addition to decompression. In contrast, it is decidedly advantageous, as recommended for the invention, to observe the low-frequency components of the images present in the compressed data set in order to generate the exposure conditions. This represents a reduced data set that reproduces the image densities with sufficient accuracy for this analysis process. Costly work steps such as decompression and resealing may thus be avoided.

In another advantageous embodiment of the invention, control data for image processing may be obtained from the transformed, quantified coefficients that correspond to the higher frequencies. With JPEG, for example, the AC components are involved. The actual frequency information of the image is contained therein. It may lead to the conclusion, whether the image contains much detail information or whether a homogenous image is involved, or also which type of image is present. Further, image tendencies may be taken from these components that are immersed in the frequency spectrum. Thus, based on the AC components, it may be determined whether an image was shaken, or whether the image data, particularly those image data present in image detail information, indicate a direction tendency. As soon as these results of the analysis of the high-frequency components are available, image processing may be correspondingly configured in order optimally to deal with this specific, analyzed image content.

One image-processing method that is advantageously and particularly suited to optimization based on the frequency spectrum, or on the control data extracted from the compressed image data is focus sharpening, or the amplification of detail information that generally results from improvement of image lines. Thus, based on the analysis of the compressed image data, it may result that sharpening the focus of a particular image might lead to a worsening of the image appearance, and thus the focus sharpening processing step should not be used at all with this image. For images that are positively influenced by sharpening, the image processing may thus be optimized based on analysis of the compressed data so that ideal focus-sharpening parameters may be selected.

Image data whose matrix components of the two-dimensional frequency spectrum (which possess extremely high frequencies) are not zero may be identified as a computer graphic, since such high frequencies do not often occur in real images, or at least not as predominantly. The invention may be particularly advantageously used with these images since they may be particularly easily identified based on compressed data, and thus both image sharpening and other corrections connected with film characteristics or similar may be omitted. With a computer graphic, it may be assumed that it has already been optimized by its creator, and thus should be reproduced in its present form without undertaking modifications.

In the case where all matrix components of the compressed image data to which higher frequencies are assigned possess higher values without a high degree of very high frequencies, it may be assumed that image data are involved that, whether within a computer program or within a digital camera, have already been sharpened. It is useful for such images not to undertake any image sharpening, or to select very small sharpening parameters, so that no artifacts caused by exaggerated sharpening may arise in the processed image.

The method according to the invention may also be advantageously used if analysis of the compressed data shows that a regular image is involved that may be improved by focus sharpening. If, for example, analysis of the components of the compressed image data shows that predominantly lower frequencies are present, it may then be assumed that very homogenous image content is involved in which image graininess or fuzziness is increased by very strong focus sharpening, but the overall image content would not be positively influenced. In this case, based on the invention, control data are so selected that small sharpening parameters are used. In the opposite case in which an image recognized to be a natural photograph contains many components of the compressed data set to which high frequencies are assigned, it is provided that the control data are so selected that strong focus sharpening is performed. It may be assumed with such images that the image content shows many details for which sharpening may produce an optimal effect in that this detailed information is more clearly presented.

As soon as the value of the matrix components clearly increases in a particular direction with respect to another direction (e.g., greater along the x-axis than along the y-axis), it may be assumed that sharp lines of the detailed information extend predominantly along a specific direction tendency. A photograph may, for example, deal with grass that is bent in a certain direction by the wind. It would be advantageous here to select sharpening parameters so that the sharpening is performed specifically perpendicular to the direction of the lines in order to promote the detail without distorting anything else. Thus, individual sharpening may be selected using the invention so that a frequency progression based on the two-dimensional frequency spectrum of the compressed image data may be determined, and this information may then be converted into control data for focus sharpening.

If the overall image data of an image in compressed form shows a direction tendency although randomly distributed higher and lower frequencies occur, it may be assumed that the image is fuzzy (the camera was moved). In this case, the different frequencies available indicate that no single image content is involved that may be arranged along a direction tendency, but rather the direction tendency is dictated by the photograph. In such a case, correction of the image error may be undertaken to a certain extent by increasing the high frequencies along the displacement direction, or i.e., along the direction tendency. This may be realized by the use of filters such as are used for image sharpening.

Another advantageous application realm for the invention is in the reduction of fuzziness or graininess that generally results during image processing. Image graininess is particularly distracting if the image contains large areas of homogenous surfaces such as large amounts of sky. In this case, strong fuzziness or graininess should be suppressed in order to give the image an optimal appearance. If, on the other hand, the image contains predominantly smaller details, image information may be lost if fuzz suppression is too strong although the fuzziness in this image content would not have been adversely affected during reproduction of the image. With the invention, it may be determined based on the compressed image data whether the image data consist of mainly high or low frequencies, so that a more or less homogenous image content may be assumed. If the compressed image data show that the image includes predominantly low frequency components, then the control data are so selected that strong reduction in fuzziness or graininess results during image processing.

Another advantageous application in which the invention may be optimally used is in maximum image enlargement. The maximum frequency within the data set may be determined based on the compressed image data. From this, an estimation of the image resolution may be assessed. If this resolution is known, the maximum enlargement factor may be derived for the photograph. Enlargement may be increased until the image gives the impression that individual points or areas are incorrectly reproduced, or that the enlargement was too great for the given resolution. The limit frequency derived from the compressed data helps determine control data that prevent excessive enlargement and is applied to the image data. Within the scope of image processing, a warning may be issued, for example, that instructs the device operator that the selected enlargement factor is unsuitable for the resolution of the image data involved, since an unsatisfactory image would result if this enlargement is used. In particular, detail resolution may be determined based on the compressed image data. From this, the extent to which an image may be reduced without total loss of detail information may be deduced. This may be used, for example, in order to select an optimal image size for index prints. For this, the size of the individual images on the index print is selected such that as little image detail as possible is lost while still fitting an acceptable number of index images onto one sheet.

A further advantageous application of the method according to the invention consists of determining the Gamma of the camera which created the image from the ratio of very high-frequency components of the compressed data set to components of the compressed data set that correspond to the lowest frequencies, and to determine the Gamma to be used for image reproduction from these control data. The Gamma value indicates the steepness of the gradation curve of the recording material or medium, or how quickly the density and the degree of darkening of the image data increase as brightness increases during the exposure. If the gradation curve is very steep, for example, then the Gamma factor is very large and the exposure range is correspondingly very small since the maximum density achievable has already been reached with relatively low brightness increase. In such a case in which the recording medium possesses a high Gamma factor, or in other words, a steep gradation curve, it is advantageous to load a flatter Gamma into the image processing before reproduction. This creates a softer image impression that better corresponds to the density progression perceived by the human eye. In order to be able optimally to control the Gamma for image reproduction, ratios between the high-frequency and low-frequency components of the compressed image data set (AC/DC components for JPEG) are formed, and are compared with the ratio of an image captured with Gamma value of 1. If the ratio indicates a greater Gamma value during image capture, then the image processing method is caused to modify the image with a flatter Gamma, and vice versa. Thus, control values for optimal configuration of the gradation of the processed data may be determined.

A further, especially advantageous application of the invention consists of obtaining control data for local alterations of image data from the transformed, quantified coefficients of individual blocks of compressed image data. Blocks of certain image areas are assigned depending on the compression algorithm, and may assume any shape or form. Blocks in compressed image data set may be assigned to specific positions of these image data in the image content of the photograph. By analysis of individual blocks, or of blocks adjacent to the compressed image data, it may be determined which photograph conditions or content characteristics the image data show at a specific image position.

Local control data for image processing of pre-determined areas of the image may then be obtained from this information that correspond to all those that were extracted from compressed image data for processing the entire image as described in the above paragraphs. The approach during determination of control data is similar to that for the entire image—the only difference is that only one, or a few, blocks are evaluated, and the control data may then be applied specifically only to the correspondingly-evaluated image areas. In this manner, the entire image may again be processed, but not with one unified control per image and image-processing step, but rather with control data that may be applied locally within an image-processing step for various areas.

So, for example, in image areas containing much detail information, the high-frequency components of the corresponding blocks are more strongly occupied than in homogenous areas. Correspondingly, other focusing parameters may advantageously be selected in the image areas that belong to the blocks with strong high-frequency components than in homogenous areas. Thus, image processing optimally adapted to the local image content may be realized.

In a further, especially advantageous application of the invention, control data for the selection of filters and/or characteristic curves employed for image processing at specific image positions are derived from the values of components of selected frequencies of the associated blocks.

A particularly advantageous realm of application for the invention is contrast modification. In order to prevent image defects caused by this (halo effects at points of strong light/dark transitions), the method according to the invention may advantageously be implemented instead of the method described in DE 197 03 063. Thus, during contrast modification in image areas in which many high frequencies occur, other filters are used to form unfocussed masks used for contrast modification of image data rather than in such areas in which deep frequencies are predominant. Since the occurrence of a large number of high frequencies in one block stands for much detail information at the corresponding point of the image, it may be assumed that many density jumps are to be expected in this area. In these areas during conventional image processing, bright stripes, for example, may occur in dark areas that are adjacent to very bright image areas, or vice versa. In order to prevent defects caused by over-correction in general, better-suited filters are used to form a mask in the area of strong density jumps. This will be explained in more detail in connection with the preferred embodiments.

Compressed image data may even be used advantageously during selection of control parameters for contrast modification. In this data set, the contrast range is directly visible in each frequency band. It may thus be directly deduced how strong the contrast must be modified in a specific frequency band so that, during image reproduction, an optimally-adjusted contrast range adapted to the reproduction medium results.

It is principally advantageous to perform a frequency analysis in order to determine the control parameters for contrast management. Compressed image data already available in frequency form are used for this, or decompressed image data would be frequency-transformed. The frequency data thus obtained are then divided into various frequency components. These components are analyzed, and control data are determined for very detailed contrast management. The contrast may be very precisely adjusted to ideal values in detail contrast and surface contrast.

Even local selection of focus-sharpening parameters may be very advantageous locally. Thus, preferably image areas that correspond to blocks with many high frequencies within the compressed data set, i.e., in areas rich in detail, are more sharply focused than are low-frequency (homogenous) image areas.

The invention may also be advantageously used in image processing that serve to optimize image colors. Thus, for example, color saturation in image areas with many image details may be selected to be much stronger than in homogenous color areas. Strongly saturated colors in image areas with much small detail and many color- and density-jumps give the impression of a pleasantly-colored, brilliant image, whereas strong color saturations in homogenous color areas may lead to an artificial, over-saturated impression. This is why, based on the invention, image areas that belong to blocks with many high frequencies are more strongly saturated than those that belong to blocks with many low frequencies. Image colors may thus be optimized locally.

Control data to select characteristic curves and/or filters that are to be applied within the scope of image processing to the corresponding image areas may be determined particularly advantageously from the ratio of high-frequency components of one or more adjacent blocks of compressed image data to the concomitant lowest-frequency components of these data. This ratio is a standard for the number of sharp image edges or jumps in density with respect to the absolute image intensity at a specific point of the image, and it specifies the only frequency information. Since the focus-sharpening parameters are selected dependent on this ratio, very dark homogenous areas can be prevented from being made fuzzy by means of focus sharpening that is too strong, which can easily occur when much detail information such as, for example, strong graininess occurs in them.

An additional advantageous embodiment of the invention consists of selecting filters and/or characteristic curves dependent on preferential tendencies of high-frequency components from within blocks. Control data for image processing are so selected that, for example, upon occurrence of a direction tendency (that indicates specified detail information such as a grain field) within the components of a block, focus sharpening or the corresponding image data occurs preferably perpendicular to the direction of the detail information in order to enable effective focus sharpening.

In another advantageous method, the compressed data of chrominance images, i.e., of a color value, are used to determine motif. If, for example, many high-frequency components in the green, compressed image data set are located within the blocks of an image area, a meadow may be assumed to be the subject. On the other hand, if one finds exclusively low frequency, high-value components in the blue image data set, the sky may be assumed to be the subject. These indicators of the probability on the photograph of the presence of specific motifs may be combined with one another and with other investigations so that some motifs may be identified beyond a doubt. If a specific motif is recognized in an image data set, the control of the image processing may be individually adapted to this image motif. One may, for example, attempt to locate the horizon as soon as the sky and the concomitant transition to land or sea is known, since a common mistake made by amateur photographers is to hold the camera at an angle, which may create the effect of flowing seas or lakes.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a flow chart of an automatic image-processing method according to the invention.

FIG. 2 is a diagram to explain the decryption of the image data set.

FIGS. 3 and 4 are diagrams to provide overview of a contrast modification undertaken by the invention.

### DETAILED DESCRIPTION OF THE PREFERRED EMBODIMENTS

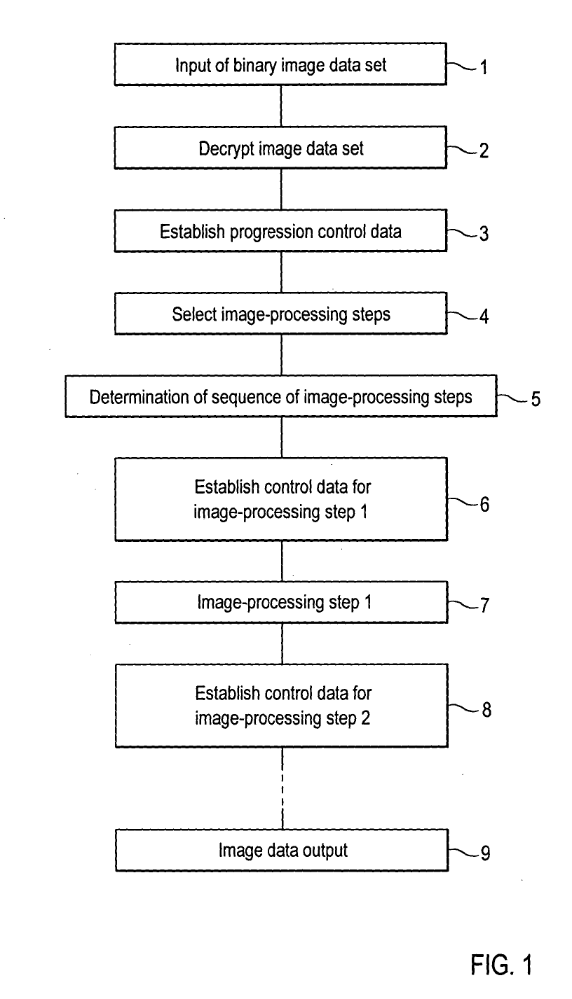

FIG. 1 gives an overview of the progression of a method for automatic image processing of digital image data in which the invention is realized. The image data to be processed enter Step 1 in binary form. These input image data are decrypted during Step 2.

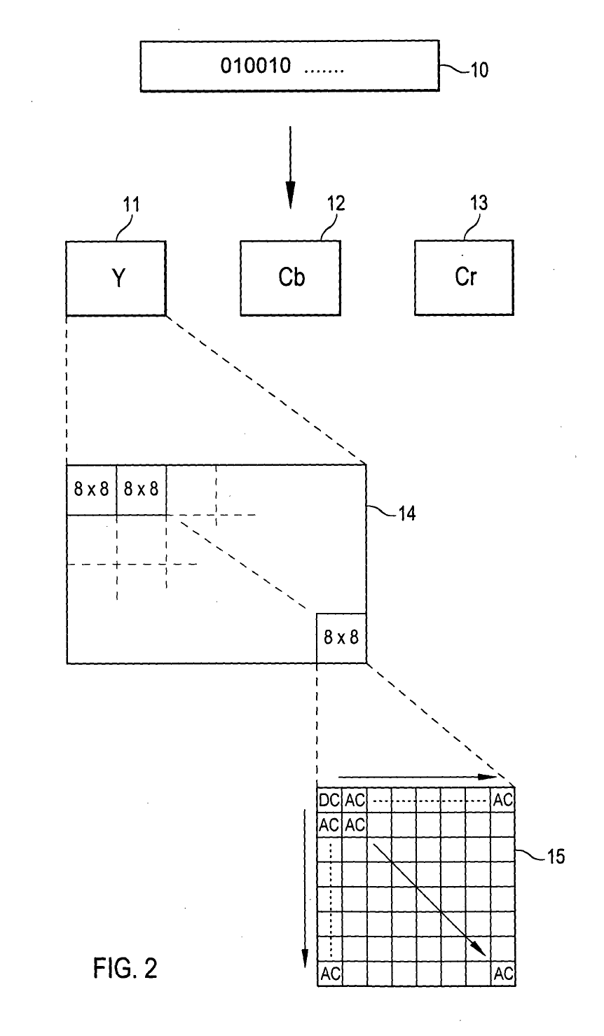

FIG. 2 shows decryption schematically, e.g., image data compressed using JPEG. The entered bit stream, a one-dimension vector, is re-converted during the decryption procedure into a two-dimensional matrix with different values. More accurately, three matrices exist after decryption: a Y-component 11 for brightness, a Cb-component 12 for one color, and a Cr-component 13 for an additional color. Such a decryption procedure is state of the art, and may found as “free-ware.” Each of the matrices is divided into value blocks of 8×8 format, as shown in 14 for Y-components. The position of these blocks within the matrix corresponds to the position of the concomitant image data in the output image. Each of these 8×8 blocks has the shape shown schematically in 15. Each block includes a DC component that is occupied by the median block value, and is located at the upper left. This component provides a determination regarding image density in the area of the 8×8 block. The other matrix values, the AC components, are frequency values where the AC components of lower frequencies are located in the vicinity of the DC components, and the AC components of very high frequencies are at the edge of the block, so the frequency increases in the direction of the arrow. If, for example, the lower right quadrant of the matrix contains only zeroes, this means that there are no image details within the image with very small expansion along the X-axis and the Y-axis. If only the AC components in the immediate vicinity of the DC components are occupied with values other than zero, then only content with very low frequency images will appear in the image; the image thus at the position assigned to the block contains very homogenous image content such as, for example, a colored surface. If high values of AC components build up at the lower left end, it may be assumed that the image includes image information expanded along one direction, such as grass in a grainfield.

The blocks obtained after decryption thus represent the local frequency spectrum at the corresponding image position. Characteristic properties of the image content may be deduced from them. Thus as Step 3 in FIG. 1 shows, control data for the progression of the image-processing method may be obtained from the decrypted image data set. If, for example, no high-frequency components may be found within the frequency spectra of the image, i.e., for JPEG, the outermost AC components in the 8×8 matrix all have the value zero, it may then be assumed that the image contains little detail information, or is very homogenous. In this case, the progression control data would ensure that graininess and fuzziness suppression are prioritized during the selection of image-processing steps in Step 4 and the determination of the sequence of them in Step 5, while, for example, image sharpening for this image will not be provided at all as an image-processing step.

As soon as the image-processing steps are selected and their sequence is established, these image-processing steps are performed sequentially, or, in order to save computer time, partially in parallel. For this, control data from the compressed image data set are determined for individual image-processing steps in Step 6. One option for this is to extract the entire image to obtain the control data. Thus, for example, the strength of fuzziness or graininess suppression may be established by using the average component of higher frequencies in the overall image. If the image includes only very deep frequencies, for example, then the fuzziness or graininess suppression may be set to be stronger than when, for example, there are still many high values in the middle frequency area.

Another option for controlling the optimization of an image-processing step consists of selecting control parameters locally and specifically for various image positions before this image-processing step at which varying conditions exist. It is often the case that an image does not include predominantly deep or high frequencies, but rather specific areas in the image are dominated by high frequencies depending on the image content while other areas are dominated by low frequencies. Thus, for example, a landscape photograph with blue sky may consist of very deep frequencies in the upper area but very high frequencies in the lower image area. In such a case, it is optimal to set fuzziness or graininess suppression in the upper, low-frequency image area to a very high level, while fuzziness or graininess suppression in the lower, very detailed image area may be employed only very sparingly so that a loss of focus or reduction of detail information is prevented. In such a case, the control data for the image processing is formed varyingly by blocks so that each block, and thereby each smaller, assigned image section receives image processing optimized to its conditions.

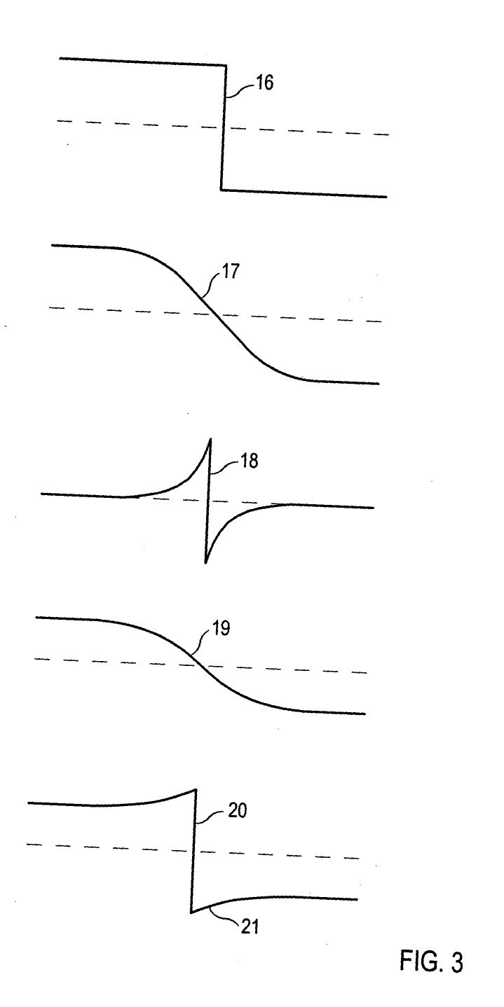

Local selection of control data for varying image positions is a particular necessity when the single image-processing method selected for an entire image leads to defective results. This may be the case for contrast reduction, for example. A review of this challenge is presented by the flow of a method for contrast compensation in FIG. 3. Contrast modification is used to reduce density jumps 16 in the density profile of the image content. This should prevent density jumps that are too strong, such as dark shadows across a face, from having a negative effect on the impression of the image. In order to moderate the contrast, a low-pass 17 is formed for the image data. This low-pass is subtracted from the original 16 so that the high-pass component 18 remains as the result. In order to perform contrast moderation of the image data, multiplying it by a factor less than one reduces the low-pass component. Thus, one obtains the reduced low-pass 19, by multiplying the low-pass by a factor of ⅔, for example. As the final step of the contrast-modification method, the reduced low-pass 19 is added to the high-pass signal 18 in order to create an image signal in which the detail information remains identical, but large-surface contrast that, for example, is noticeable with dark facial shadows, is reduced. The contrast-reduced function is shown in 20. Although it is desirable in general to obtain the detail information by means of addition of the original high-pass signal 18, so-call over-oscillations 21 may occur at density steps in the image, as shown in this example. These over-oscillations appear in the image as distracting halos, and their influence is therefore so distracting that they may be seen far into the homogenous image areas.

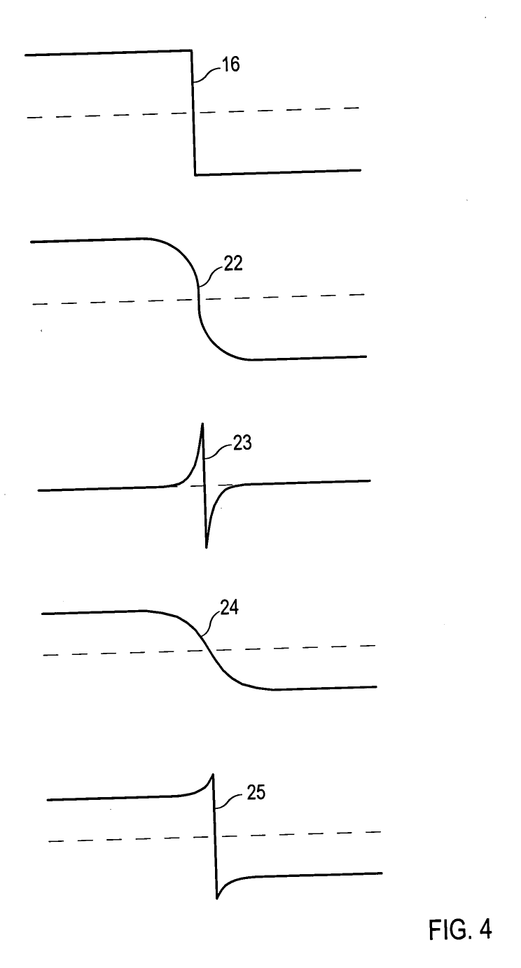

By locally selecting varying deep-pass filters, this may be avoided. Thus, based on the invention, filter frequencies of the low-pass filter are set high during low-pass formation at edges in the density profile, i.e., in the area of high frequencies in the compressed data set, while, farther from the edges, i.e., in areas of homogenous image content, filter frequencies of the low-pass filter are left low. A locally optimized low-pass 22 shown, for example, in FIG. 4 results using this approach based on the invention. If one were to subtract this low-pass from the original data 16, a high-pas signal 23 results, whose remainder is reduced to the direct vicinity of the edge. This reduced low-pass signal is now added to the high-pass signal 23 as in FIG. 3 so that the processed result 25 a reduction in contrast is produced. These image data that are deduced by a contrast modification signal for which the filter may be selected locally are dependent on the control data derived from the analyzed, compressed image data and show many fewer noticeable halo effects. The over-oscillations are reduced to very small edge sections along the edge, and are thus barely visible in the resulting image. By means of such local selection of the filters based on the evaluation of the compressed image data, shortcomings to conventional methods may be compensated during the “contrast modification” image-processing step.

All image-processing steps provided in the scope of the image processing method are expanded by the invention in that, before application of a particular image-processing step, control data for this step are determined based on analysis of the compressed image data set. Thus, based on the control data acquired, the image-processing steps may, on the one hand, be optimally selected, and on the other, optimal image-processing parameters may be adapted both to the entire image and to local image content. In this manner, image processing may be optimal for any image or image content, and image defects and image processing errors may be eliminated to a very great extent. If the data for image reproduction (Step 9) must be available more quickly, then an approach may be selected in which only those control data recognized to be significant for these image data are determined, but the additional subsequent image-processing steps to be performed may be realized using the conventional method and standard parameters.

The described method may, of course, be applied to both color components 12 and 13 in the same manner as applied to brightness component 11. Control data may, however, also be obtained from a combination of the analysis of the compressed data for the brightness value with an analysis of the compressed data of the color components.

Particularly when identifying motifs, which is particularly advantageous for the individual control of image-processing steps, it is desirable to have conclusions that result from both the investigation of image densities as well as the investigation of the available color information. Although the embodiment example was limited to the use of JPEG, especially in the decrypting step, the invention is not limited to this compression process. It is applicable to any image data set to be processed that has been frequency-transformed into compressed form, since the principal advantage lies in the use of the frequency spectrum already available in the compressed data set to control the image processing. Thus, for example, blocks are also formed using JPEG 2000 that include components that are assigned to specific frequencies. Simply put, there is a block with “DC” components and several with “AC” components with increasing frequencies and magnitudes. The components within the blocks may be assigned to the specific image positions from whose image data they were formed. Thus, assignment of compressed data to frequency and image position is also possible. It is significant for the invention whether the image-processing steps are applied to the still-compressed data, or whether the image data are decompressed before processing, and then re-compressed before output to Step 9.

There has thus been shown and described a novel method for automated processing of digital image data which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. Method for automated processing of digital image data, wherein the input image data are in compressed form, and wherein several image-processing steps are applied to at least one of said compressed image data and, if the image data has been decompressed, said decompressed image data, the improvement wherein the image-processing steps are automatically controlled based upon control data extracted from the compressed image data.

2. Method as recited in claim 1, wherein the image-processing steps to be applied are selected based on the extracted control data.

3. Method as recited in claim 1, wherein image-processing parameters for the image-processing steps are selected based on the extracted control data.

4. Method as recited in claim 1, wherein control data are obtained from one of the color channels.

5. Method as recited in claim 1, wherein control data are obtained from the transformed, quantified, or de-quantified coefficients of the image data.

6. Method as recited in claim 5, wherein the control data are obtained from the transformed, quantified, or de-quantified coefficients of the overall image data.

7. Method as recited in claim 1, wherein the control data are obtained from the transformed, quantified, or de-quantified coefficients that correspond to the lowest frequencies (DC components for JPEG).

8. Method as recited in claim 7, wherein the control data are formed to provide a selection of the gradation characteristic curve to be used for the densities during reproduction of the digital image data.

9. Method as recited in claim 1, wherein the control data are obtained from the higher-frequency components of the transformed, quantified, or de-quantified coefficients (AC components for JPEG).

10. Method as recited in claim 9, wherein image data that include extremely high frequencies are identified as computer-generated graphics, and which are not corrected for film characteristics.

11. Method as recited in claim 9, wherein parameters for focus sharpening of image data are selected to be very small if the values of the high-frequency components are constantly very high.

12. Method as recited in claim 9, wherein parameters for focus sharpening are selected to be very small if the high frequency of the components of the compressed data are under-occupied.

13. Method as recited in claim 9, wherein parameters for focus sharpening of image data are selected based on the frequency progression of the components of the compressed data.

14. Method as recited in claim 9, wherein a fuzzy photograph is identified upon recognition of a direction tendency based on all components of the compressed data, and high frequencies are increased along the direction of camera motion.

15. Method as recited in claim 9, wherein larger fuzziness or graininess suppression parameters are selected when the components are dominated by lower frequencies.

16. Method as recited in claim 9, wherein the enlargement factor for the image reproduction is controlled based on the frequency spectrum.

17. Method as recited in claim 7, wherein the gradation characteristic curve or the Gamma value used for the processing is selected in dependence upon the ratio of high to low frequency components.

18. Method as recited in claim 5, wherein local control data are extracted from the transformed, quantified, or de-quantified coefficients of individual blocks of the compressed data.

19. Method as recited in claim 18, wherein the selection of filters and characteristic curves applied to the image data assigned to the block is performed in dependence upon the value of selected frequency ranges of the compressed image data of these blocks.

20. Method as recited in claim 18, wherein the selection of filters and characteristic curves applied to the image data assigned to the block is performed in dependence upon the ratio of high to low-frequency components of the compressed image data of these blocks.

21. Method as recited in claim 18, wherein the selection of filters and characteristic curves applied to the image data assigned to the block is performed in dependence upon the amassments of components of the compressed image data within the blocks.

22. Method as recited in claim 18, wherein the components of the compressed image data of chrominance images are evaluated by block in order to identify the motif.
